(19) United States
(12) Patent Application Publication
(10) Pub. No.: US 2005/0262256 A1
(43) Pub. Date: Nov. 24, 2005

(54) Method and device for multimedia processing

(75) Inventor: Chih-Hao Cheng, Hsinchu City (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/111,056

(22) Filed: Apr. 21, 2005

(30) Foreign Application Priority Data
Apr. 22, 2004 (TW) 93111218

(51) Int. Cl. G06F 15/16

(52) U.S. Cl. 709/231

(57) ABSTRACT

A method and a device for multimedia processing are provided. The device includes a processing unit, a DSP chip, and an output unit. The DSP chip has a first stream data generator, a second stream data generator, and a stream manager. The first streamed data generator produces first stream data for a first program. The second streamed data generator produces second stream data for the second program. The stream manager is provided for receiving the first streamed data and/or the second streamed data. When the first streamed data and the second streamed data are produced at the same time, the stream manager mixes the first streamed data and the second streamed data to generate a mixed data.

### CROSS-REFERENCE TO RELATED APPLICATIONS

This application claims the right of priority based on Taiwan Patent Application No. 093111218 entitled “Method and Device for Multimedia Processing,” filed on Apr. 22, 2004, which is incorporated herein by reference and assigned to the assignee herein.

### FIELD OF INVENTION

The present invention relates to a multimedia device and a method for processing stream data.

### BACKGROUND OF THE INVENTION

Nowadays, mobile phones have become indispensable to many people. However, simply voice-based mobile phones are getting unable to satisfy the needs of many users. Mobile phones of the next generation, or so-called “Smart phones”, tend to provide more functions than phone conversation, such as the internet access, personal information management, e-mails, multimedia file processing, etc.

In general, the mobile phones alleging the multimedia support are equipped with at least color display panels and compact digital cameras. And the mobile phones capable of running MP3, movie clips, or digital audio broadcasting (DAB) under a few operating systems (Palm, Pocket PC, or Symbian) are still rare.

In addition to the suitable operating systems, powerful hardware is demanded because processing multimedia files would consume a lot of system resources. Typically, a processor running at 200 MHz meets the minimum requirement for these tasks, and a processor running at or above 400 MHz performs processing these kinds of multimedia files satisfactorily.

Multimedia files for movie clips are categorized as WMV, MPG or RM formats, and for audio clips are categorized as MP3, WMA, or RM formats. Different formats require different software programs to run, such as Windows Media, Pocket DivX, WinMp3, etc.

Due to the issues of cost and power consumption, the operating system installed in the current multimedia mobile phone, such as a “Smart Phone,” is unable to compete with the one in PC when, in particular, “multitask processing” or “real-time processing” is involved. And running multimedia functions in real time in addition to basic voice communication functions, current mobile phones barely satisfy the users because of the lagged performance. Take a “Smart Phone” for example: it can have ring tones in simple MIDI format or in MP3 format which requires further digital signal processing. When a user plays an MP3 by the “Smart Phone” and a call is coming, the processor of the “Smart Phone” has to coordinate the MP3 playing program and the ring-tone playing program. The processor would suspend the MP3 playing program and release the resource of the DSP to the ring-tone program to decode a ring-tone file. And after the ring-tone program is terminated, the MP3 playing program resumes. This configuration is complicated, and it needs additional means to make the MP3 resume playing from where it was suspended.

Accordingly, it is advantageous to have an invention addressing these and other problems associated with the prior art.

### SUMMARY OF THE INVENTION

One aspect of the present invention is to provide a multimedia processing device and a method for processing stream data.

Another aspect of the present invention is to provide a method for processing stream data produced by different sources within a multimedia processing device.

Still another aspect of the present invention is to provide a Smart Phone, and a method for processing stream data in the mobile phone.

One feature of the present invention lies on a stream manager disposed on the stream data transmission path between the “stream data generators” and the “stream data output unit,” for mixing stream data produced by different sources according to a ratio. The stream manager adjusts the ratio based on different conditions. No matter what the ratio is, the stream data generators corresponding to the stream data are not affected or interrupted, and thus the whole operating efficiency is maintained.

In one embodiment, a multimedia processing device includes a processor, a digital signal processing (DSP) chip, and an output unit. The DSP chip includes a first stream data generator, a second stream data generator, and a stream manager. The processor executes a first program and a second program. The first stream data generator produces first stream data for the first program, and the second stream data generator produces second stream data for the second program. The stream manager receives the first stream data or the second stream data or both. When the first stream data and the second stream data simultaneously concurs, the stream manager mixes the first stream data with the second stream data to generate first mixed data according to a ratio.

Also disclosed is a method for processing stream data in a multimedia processing device. The method includes: (a) producing first stream data by the processor running a first program; (b) producing second stream data by the processor running a second program; (c) receiving the first stream data and/or the second stream data; (d) mixing the first stream data and the second stream data to generate first mixed data according to a ratio when the first stream data and the second stream data simultaneously concurs; and (e) outputting the first mixed data.

The foregoing and other features of the invention will be apparent from the following more particular description of embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1a is an illustration of a multimedia processing device according to an embodiment of the present invention;

FIG. 1b is an illustration of a multimedia processing device according to another embodiment of the present invention;

FIG. 2 is an illustration of a multimedia processing device according to still another embodiment of the present invention;

FIG. 3 is a flowchart of a method according to an embodiment of the present invention; and

FIG. 4 is a flowchart of a method according to another embodiment of the present invention.

### DETAILED DESCRIPTION

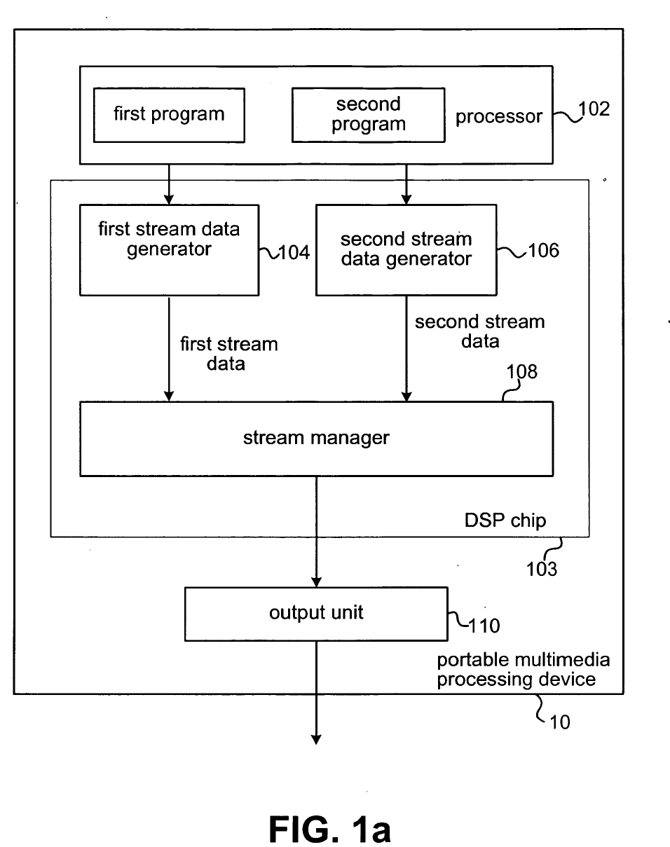

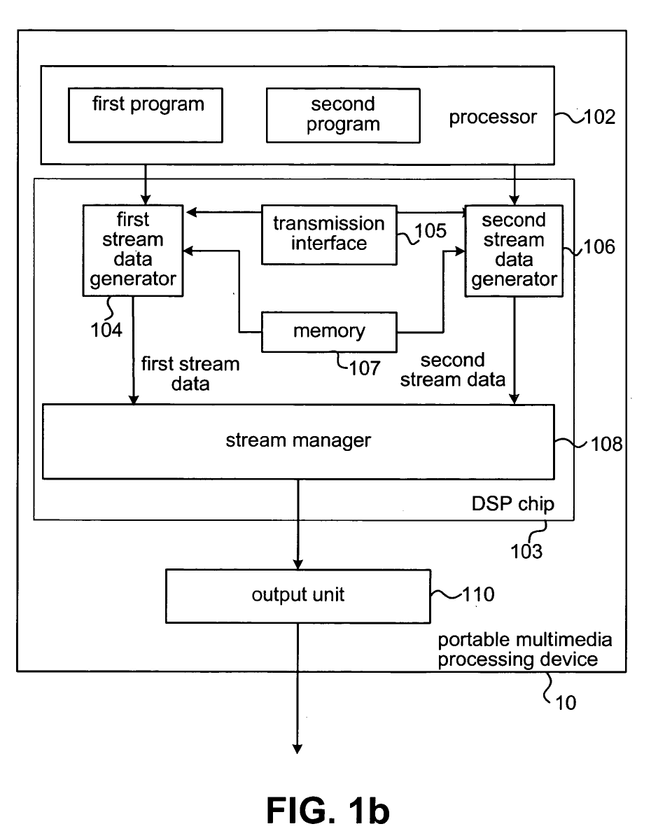

Referring to FIG. 1a, a portable multimedia processing device 10 includes a processor 102, a digital signal processing (DSP) chip 103, and an output unit 110. The DSP chip 103 includes a first stream data generator 104, a second stream data generator 106, and a stream manager 108. The processor 102 executes a first program and/or a second program that are installed in the device 10. The first stream data generator 104 produces first stream data for the first program, and the second stream data generator 106 produces second stream data for the second program. The stream manager 108 receives the first stream data or the second stream data, or both. When the first stream data and the second stream data are generated during the same time, the stream manager 108 mixes the first stream data with the second stream data to generate first mixed data according to a first ratio. The output unit 110 is provided for outputting the first mixed data. Those skilled in the art should appreciate that though the present invention is described with reference to the following embodiments, any suitable multimedia processing device including “Smart phones,” PDAs, portable digital music players, digital audio broadcasting players, “smart consumer electronics,” and the likes are also covered in the scope of the present invention.

In an embodiment shown in FIG. 1a, the processor 102 is a RISC (Reduced Instruction Set Computing) processor. The first program is a CD playing program, and the second program is a mini-disc (MD) playing program. The DSP chip 103 is a programmable DSP chip. The first stream data generator 104 functions as a CD player, and the second stream data generator 106 functions as a MD player. When the processor 102 runs the CD playing program, the first stream data generator 104 produces CD stream data; when the processor 102 runs the MD playing program, the second stream data generator 106 produces MD stream data. Typically, both the CD stream data and the MD stream data are produced based on Pulse Code Modulation (PCM), as known to those skilled in the art. The stream manager 108 receives the CD stream data or the MD stream data or both. When the CD playing program and the MD playing program are executed concurrently, the CD stream data and the MD stream data are produced at the same time. Then the stream manager 108 mixes the received CD stream data and the received MD stream data to generate the first mixed data. The output unit 110, including an audio drive, converts the first mixed data to be perceived by the user.

The stream manager 108 can perform the mixing of the received data according to the sampling rate, the amplification, or the frequency spectrum of the audio data. In an example, the sampling rate of the first stream data generator 104 and the second stream data generator 106 are both 44 KHz. According to a ratio of “50□50.” The stream manager 108 re-samples the CD stream data and the MD stream data at 22 KHz respectively, mixes them by using the linear interpolation, and outputs the mixed data with the sampling rate at 44 KHz. In addition, prior to being received by the stream manager 108, the CD stream data and the MD stream data can perform the “sound balancing” with respect to the frequency spectrum.

The portable multimedia processing device 10 also operates under a real time operating system (RTOS), whereby the first stream data is produced in real time by the first stream data generator 104 and so is the second stream by the second stream data generator 106. As a result, the first program and the second program can be run more efficiently. However, in another embodiment, the device 10 operates under a non-real time operating system.

Alternatively, the first stream data generator 104 and the second stream data generator 106 produce indirectly the first stream data and the second stream data. The first stream data generator 104 is connected to an external CD player (not shown) via a transmission interface 105 in FIG. 1b. The produced CD stream data of the external CD player is provided to the first stream data generator 104 via the interface 105, and then is relayed to the stream manager 108. The transmission interface 105 can use a wired linkage (e.g., USB connection), or a wireless linkage (e.g., IEEE 802.11b connection).

In an embodiment shown in FIG. 1b, the device 10 includes a memory 107 for storing an audio file, and the first stream data generator 104 produces the first stream data according to the audio file. For example, the memory 107 includes a flash memory card for storing an MP3 file. The first stream data generator 104 decodes the MP3 file to produce MP3 stream data as the first stream data. Alternatively, the flash memory card stores a WAV file. The second stream data generator 106 produces WAV stream data as the second stream data according to the WAV file. The stream manager 108 receives the MP3 stream data or the WAV stream data, or both. When the MP3 stream data and the WAV stream data are generated concurrently, the stream manager 108 mixes the MP3 stream data and the WAV stream data to generate the first mixed data, which is then outputted by the output unit 110. Thus the MP3 stream data or the WAV stream data can be heard concurrently.

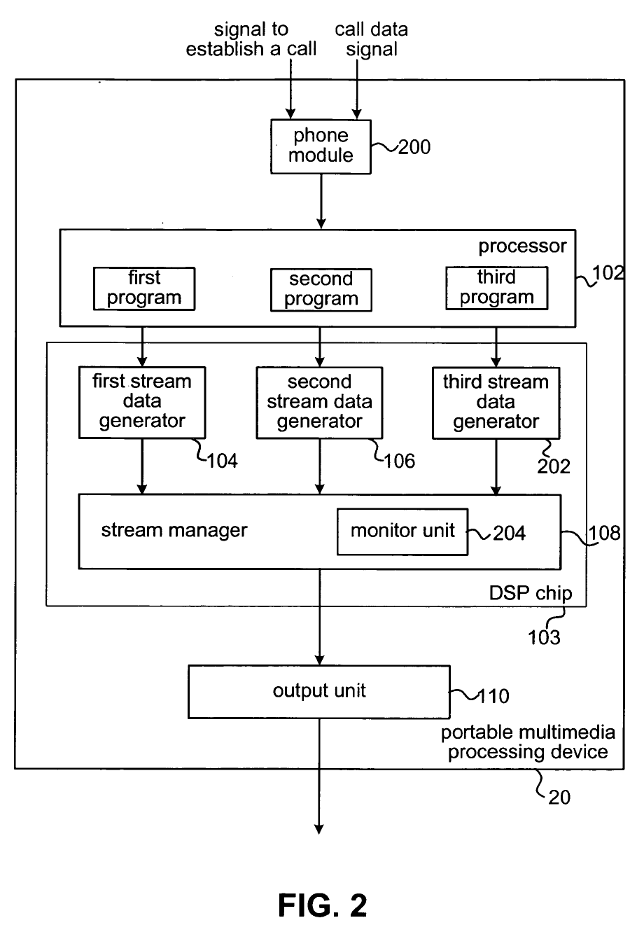

Referring to the FIG. 2 for another embodiment, the portable multimedia processing device 20 includes a phone module 200. If the first program is running while the phone module 200 receives a signal to establish an incoming call, the processor 102, in response to the signal, activates the second program to produce the second stream data. The device 20 further includes a third stream data generator 202, wherein when the incoming call is established, the phone module 200 receives a call data signal, the third stream data generator 202 generates third stream data according to the call data signal, and the stream manager 108 stops receiving the second stream data and starts to receive the third stream data. Then the stream manager 108 mixes the first stream data with the third stream data to generate second mixed data according to a second ratio, and the output unit 110 further outputs the second mixed data. The stream manager 108 further includes a monitor unit 204 monitoring the first stream data and the third stream data for adjusting the second ratio.

For example, the first program is an MP3 playing program, and the first stream data generator 104 produces MP3 stream data. The second program is a ring-tone program, and the second stream data generator 106 produces ring-tone stream data corresponding to the second program and a ring-tone file stored in the memory (as the memory 107 in FIG. 1b). If the MP3 playing program is running while the phone module 200 receives a signal to establish an incoming call, the processor 102, in response to the signal, activates the second program to provide ring-tone stream data. Then the stream manager 108 mixes the MP3 stream data and the ring-tone stream data to generate first mixed data according to a first ratio, thereby the MP3 stream data and the ring-tone stream data can be heard concurrently. In other words, the ring-tone program can notify the user of an incoming call without interrupting the MP3 playing program. If the user refuses the call, the ring-tone program is terminated and the MP3 playing program keeps going. At the time, the output unit 110 outputs only the MP3 stream data.

As describes above, the device 20 further includes a third stream data generator 202. In this embodiment, the third stream data generator 202 is a call stream data generator. When the incoming call is established, the phone module 200 starts to receive a call data signal, the call stream data generator 202 generates call stream data according to the call data signal, and the stream manager 108 stops receiving the ring-tone stream data and starts to receive the call stream data. At the same time, the ring-tone program is terminated. Then the stream manager 108 mixes the MP3 stream data with the call stream data to generate the second mixed data according to a second ratio, and the output unit 110 further outputs the second mixed data. In addition, if the monitor unit 204 determines that the amplification of the call stream data is lower than the one of the MP3 stream data, the monitor unit 204 adjusts the second ratio to increase the portion of the call stream data in the second mixed data, whereby the output call stream data would not be dominated by the output MP3 stream data. In an example, the second ratio is adjusted to eliminate the portion of the MP3 stream data; that is, the ratio of the call stream data to the MP3 stream data becomes “100:0”, and the second mixed data is made up of the call stream data only.

For embodiment shown in FIG. 2, when the user of the device 20 inputs a response signal (e.g., by talking to the device 20) to answer the incoming call, the call stream data generator 202 produces response stream data according to the response signal from the user. The stream manager 108 mixes the MP3 stream data with the response stream data to generate second mixed data according to a second ratio. The output unit 110 outputs the second mixed data and further transmits it to the caller of the incoming call. Accordingly, the caller can hear the response stream data and the MP3 stream data at the same time. The monitor unit 204 is provided for monitoring the response stream data and the MP3 stream data. Before the call is terminated, if the amplification of the response stream data is lower than a predetermined level, the monitor unit 204 increases the portion of the MP3 stream data. This condition applies when the user holds the caller but does not hang up.

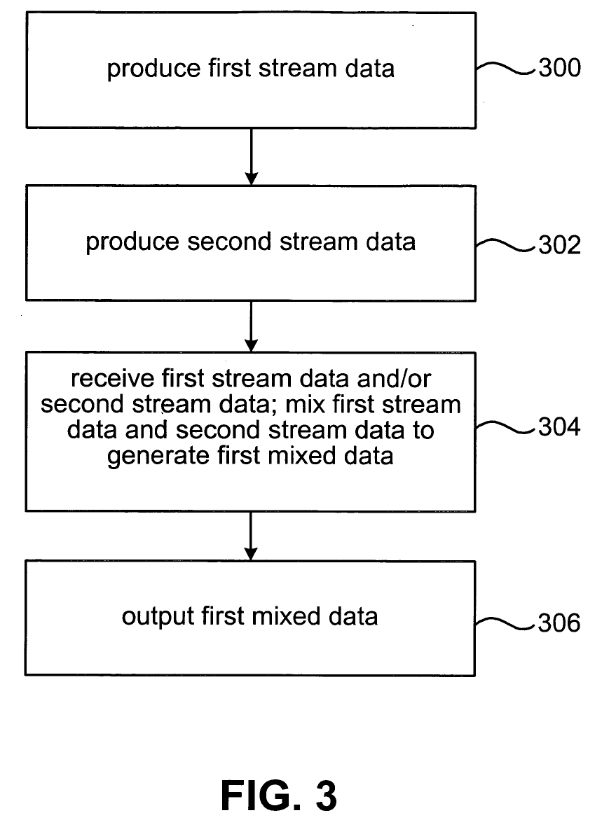

Referring to FIG. 3, an exemplary method of the present invention is described with reference to the embodiment shown in FIG. 1b. The step 300 is to produce first stream data within the device 10 by running a first program, and the step 302 is to produce second stream data within the device 10 by running a second program. Note that the first stream and the second stream can be respectively produced according to a stored file, such as an MP3, a MIDI, or a WAV, but the stored file should not be construed as essential in the present invention. Step 304 includes receiving the first stream data and/or the second stream data, and mixing the first stream data and the second stream data to generate first mixed data according to a first ratio when the first stream data and the second stream data simultaneously concurs. In the step 306, the first mixed data is output.

In FIG. 1b, alternatively, the second stream data generator 106 is a DAB stream data generator for producing DAB stream data. The device 10 operates under a RTOS, whereby the MP3 stream data is produced in real time by the first stream data generator 104 and so is the DAB stream by the second stream data generator 106. The stream manager 108 receives the MP3 stream data or the DAB stream data or both. When the MP3 stream data and the DAB stream data are generated concurrently, the stream manager 108 mixes the MP3 stream data and the DAB stream data to generate the first mixed data which is then outputted by the output unit 110. Moreover, the stream manager 108 can adjust the first ratio corresponding to different conditions.

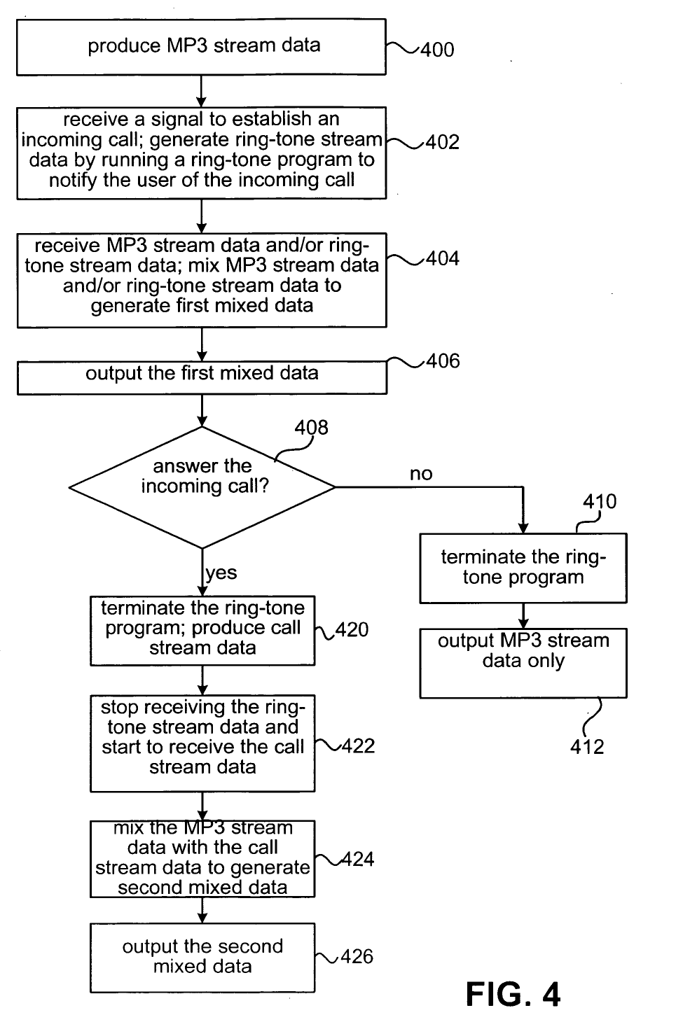

Referring to FIG. 4, another exemplary method is described with reference to a “Smart Phone.” In the beginning, the phone produces MP3 stream data according to an MP3 file by running an MP3 playing program (step 400). The phone receives a signal to establish an incoming call, and, in response to the signal, generates ring-tone stream data by running a ring-tone program to notify the user of the incoming call (step 402). The ring-tone stream data is produced according to a stored ring-tone file which may be of MIDI format or MP3 format. The MP3 stream data and/or the ring-tone stream data are received. If they are produced concurrently, they are mixed to generate a first mixed data according to a first ratio (step 404). And the first mixed data is output (step 406). Therefore, when the MP3 is playing, the phone plays the ring-tone file as a notifier without suspending the MP3, and the user decides whether to answer the call (step 408). If the user refuses to answer the call, the ring-tone program is terminated (step 410). Then the MP3 playing program keeps running, and only the MP3 stream data is output (step 412).

For another embodiment shown in FIG. 2, if the incoming call is established, the multimedia phone 20 receives a call data signal, terminates the ring-tone program, and drives the call stream data generator 202 to produce call stream data (step 420). The stream manager 108 stops receiving the ring-tone stream data and starts to receive the call stream data (step 422). The stream manager 108 mixes the MP3 stream data with the call stream data to generate the second mixed data according to a second ratio (step 424), and then the second mixed data is output (step 426). In another embodiment, the user can adjusts the second ratio according to different conditions. The second ratio can be dynamically adjusted based on the sampling rate, the amplification, or the frequency spectrum of the MP3 stream data and the call stream data.

It should be note that the steps of FIG. 3 and FIG. 4 describe specific operations occurring in a particular order. In alternative implementations, some steps may be performed in a different order. Moreover, steps may be added to the above described methods and still conform to the spirits of the invention.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1 . A multimedia processing device, in which a first program and a second program are installed, said device comprising:
a processor for executing said first program and said second program;
a digital signal processing (DSP) chip, comprising:
a first stream data generator for producing first stream data corresponding to said first program;
a second stream data generator for producing second stream data corresponding to said second program;
a stream manager for receiving said first stream data and/or said second stream data, wherein, when said first stream data and said second stream data simultaneously concurs, said stream manager mixes said first stream data with said second stream data to generate first mixed data according to a first ratio; and
an output unit, connected to said DSP chip, for outputting said first mixed data.

2. A device according to claim 1, further comprising:
a memory for storing an audio file;
wherein said first stream data generator produces said first stream data based on said audio file.

3. A device according to claim 1, wherein said DSP chip is operated under a real time operating system (RTOS).

4. A device according to claim 1, further comprising:
a phone module;
wherein when said phone module receives a signal to establish an incoming call, said processor, in response to said signal, activates said second program to provide said second stream data.

5. A device according to claim 4, wherein said second stream data is ring-tone data.

6. A device according to claim 4, further comprising:
a third stream data generator;
wherein, when said incoming call is established, said phone module receives a call data signal, said third stream data generator generates third stream data according to said call data signal, and said stream manager stops receiving said second stream data and starts to receive said third stream data;
wherein said stream manager mixes said first stream data with said third stream data to generate second mixed data according to a second ratio, and said output unit further outputs said second mixed data.

7. A device according to claim 6, wherein said stream manager further comprises a monitor unit monitoring said first stream data and said third stream data for adjusting said second ratio.

8. A device according to claim 1, wherein said device is a mobile phone.

9. A device according to claim 1, wherein said processor is operated under a non-real time operating system.

10. A method for a multimedia processing device to process stream data, said device comprising a processor and a DSP chip, said method comprising:
(a) producing first stream data by said processor running a first program;
(b) producing second stream data by said processor running a second program;
(c) receiving, by said DSP chip, said first stream data and/or said second stream data;
(d) mixing, by said DSP chip, said first stream data and said second stream data to generate first mixed data according to a first ratio when said first stream data and said second stream data simultaneously concurs; and
(e) outputting said first mixed data.

11. A method according to claim 10, prior to the step (a), said method further comprising:
(f) storing an audio file;
wherein the step (a) further comprises:
producing said first stream data based on said audio file.

12. A method according to claim 10, wherein said DSP chip is operated under a real time operating system (RTOS).

13. A method according to claim 10, further comprising:
(g) configuring said first ratio.

14. A method according to claim 10, said device further comprising a phone module for receiving a signal to establish an incoming call, the step (b) further comprising:
in response to said signal, activating said second program to produce said second stream data.

15. A method according to claim 14, wherein said second stream data is ring-tone data.

16. A method according to claim 10, further comprising:
(h) receiving a call data signal when said incoming call is established, and providing said processor with a third program to produce third stream data according to said call data signal
(i) mixing, by said DSP chip, said first stream data with said third stream data to generate second mixed data according to a second ratio; and
(j) outputting said second mixed data.

17. A method according to claim 16, further comprising:
(k) configuring said second ratio.

18. A method according to claim 17, wherein the step (k) further comprises:
monitoring said first stream data and said third stream data to adjust said second ratio.

19. A method according to claim 10, wherein said device is a mobile phone.
